(19) United States
(12) Patent Application Publication
(10) Pub. No.: US 2013/0312433 A1
(43) Pub. Date: Nov. 28, 2013

(54) MAGNETIC ATTENUATOR

(71) Applicant: Paul Nemit, JR., Waynesboro, PA (US)

(72) Inventor: Paul Nemit, JR., Waynesboro, PA (US)

(73) Assignee: JOHNSON CONTROLS TECHNOLOGY COMPANY, Holland, MI (US)

(21) Appl. No.: 13/983,076

(22) PCT Filed: Jan. 31, 2012
(86) PCT No.: PCT/US2012/023269

§ 371 Date: Aug. 1, 2013

Related U.S. Application Data
(60) Provisional application No. 61/443,832, filed on Feb. 17, 2011.

(51) Int. Cl. F24F 13/24; F16F 6/00

(52) U.S. Cl. CPC F24F 13/24; F16F 6/00
USPC 62/56; 62/296; 188/267

(57) ABSTRACT

An apparatus including a magnetic attenuator substantially surrounding a non-rotatable portion of the apparatus. The magnetic attenuator achieves a reduction of vibration associated with operation of the apparatus during operation of the magnetic attenuator

### CROSS-REFERENCE TO RELATED APPLICATIONS

This application claims priority from and the benefit of U.S. Provisional Application No. 61/443,832, entitled MAGNETIC ATTENUATOR, filed Feb. 17, 2011, which is hereby incorporated by reference.

### BACKGROUND

The application relates generally to vibration attenuation systems. The application relates more specifically to vibration attenuation systems and methods using magnetic attenuation.

Vibration is one of the most difficult characteristics to manage in an apparatus, such as an apparatus including a control system. For example, a vapor compression system used in heating, ventilation and air conditioning and refrigeration (HVAC&R) would greatly benefit from a reduction or dampening of vibrations and associated noise generated during operation of the system. Currently, vapor compression systems use expensive mufflers or material applied to component surfaces of the vapor compression system, sometimes referred to as lagging material, to achieve vibration/noise reduction. However, in addition to their purchase cost, mufflers or lagging materials can restrict heating or cooling, as well as air flow in the vapor compression systems, thereby reducing operating efficiencies.

Accordingly, an attenuation system that operates without these associated disadvantages is highly desirable.

### SUMMARY

The present invention is directed to an apparatus including a magnetic attenuator substantially surrounding a non-rotatable portion of the apparatus. The magnetic attenuator achieves a reduction of vibration associated with operation of the apparatus during operation of the magnetic attenuator.

The present invention is directed to a method of reducing noise associated with an apparatus including installing a magnetic attenuator substantially surrounding a non-rotatable portion of the apparatus.

### BRIEF DESCRIPTION OF THE DRAWINGS

FIG. 1 shows an exemplary embodiment for a heating, ventilation and air conditioning (HVAC&R) system.

FIG. 2 shows an exemplary embodiment of a compressor unit of a heating, ventilation, air conditioning and refrigeration (HVAC&R) system.

FIG. 3 schematically illustrates an exemplary embodiment of an HVAC&R system.

FIG. 4 schematically illustrates an exemplary embodiment of a compressor unit of an HVAC&R system including an attenuation system.

### DETAILED DESCRIPTION OF THE EXEMPLARY EMBODIMENTS

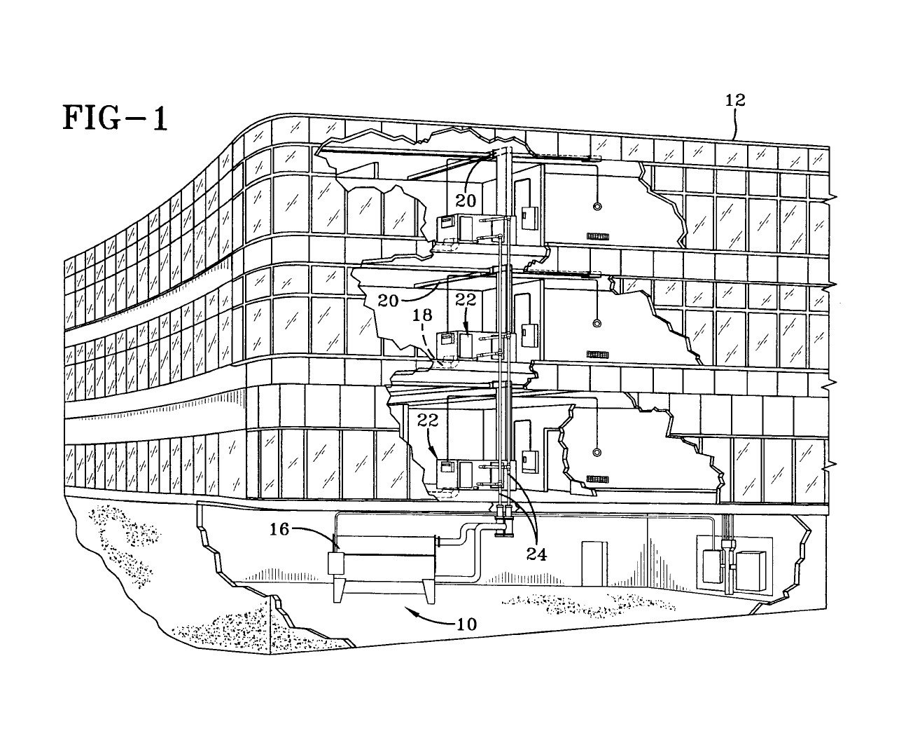

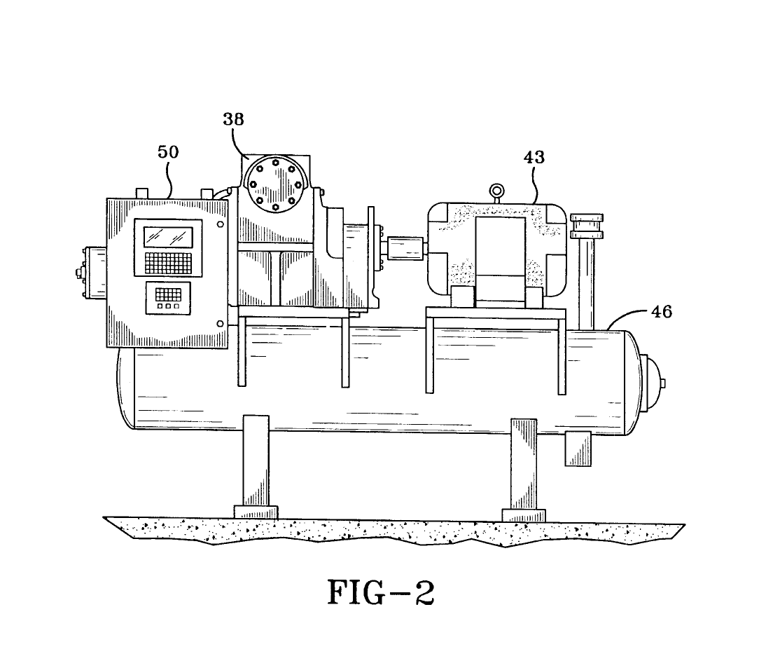

FIG. 1 shows an exemplary environment for an HVAC&R system 10 in a building 12 for a typical commercial setting. System 10 may include a compressor (not shown) incorporated into a chiller 16 that can supply a chilled liquid that may be used to cool building 12. In one embodiment, compressor 38 may be a screw compressor 38 (see for example, FIG. 2). In other embodiments compressor 38 may be a centrifugal compressor or reciprocal compressor (not shown). System 10 includes an air distribution system that circulates air through building 12. The air distribution system can include an air return duct 18, an air supply duct 20 and an air handler 22. Air handler 22 can include a heat exchanger (not shown) that is connected to a boiler (not shown) and chiller 16 by conduits 24. Air handler 22 may receive either heated liquid from the boiler or chilled liquid from chiller 16, depending on the mode of operation of HVAC&R system 10. HVAC&R system 10 is shown with a separate air handler on each floor of building 12, but it will be appreciated that these components may be shared between or among floors. In another embodiment, the system 10 may include an air-cooled chiller that employs an air-cooled coil as a condenser. An air-cooled chiller may be located on the exterior of the building—for example, adjacent to or on the roof of the building.

FIG. 2 shows an exemplary embodiment of a screw compressor in a packaged unit for use with chiller 16. The packaged unit includes a screw compressor 38, a motor 43 to drive screw compressor 38, and a control panel 50 to provide control instructions to equipment included in the packaged unit, such as motor 43. An oil separator 46 can be provided to remove entrained oil (used to lubricate the rotors of screw compressor 38) from the discharge vapor before providing the discharge vapor to its intended application.

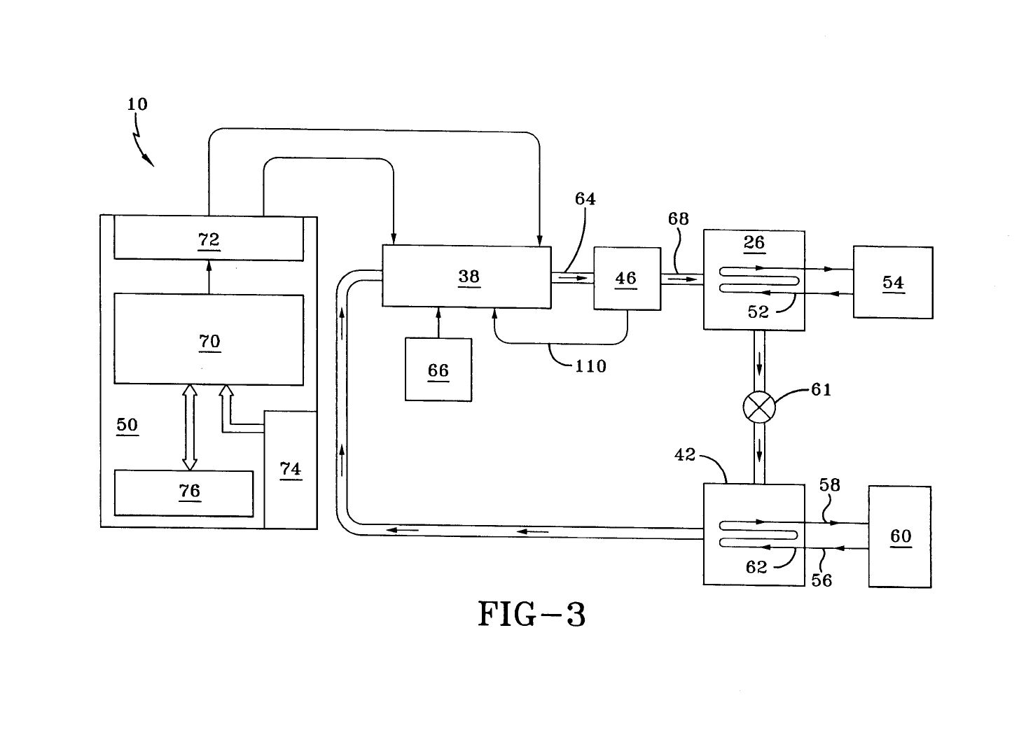

FIG. 3 shows an exemplary HVAC&R or liquid chiller system 10, which includes compressor 38, condenser 26, water chiller or evaporator 42, and a control panel 50. Control panel 50 may include a microprocessor 70, an interface board 72, an analog-to-digital (A to D) converter 74, and/or a non-volatile memory 76. Control panel 50 may be positioned or disposed locally and/or remotely to system 10. Control panel 50 receives input signals from system 10. For example, temperature and pressure measurements may indicate the performance of system 10. The signals may be transmitted to components of system 10, for example, a compressor capacity control signal, to control the operation of system 10. Conventional liquid chiller or HVAC&R system 10 may include other features that are not shown in FIG. 3 and have been purposely omitted to simplify the drawing for ease of illustration. While the following description of system 10 is in terms of a liquid chiller system, it is to be understood that the invention could be applied to any refrigeration system or any HVAC&R system.

Compressor 38 compresses a refrigerant vapor and delivers the vapor to condenser 26 through a discharge line 68. Compressor 38 may be any suitable type of compressor including screw compressor, reciprocating compressor, scroll compressor, rotary compressor or other type of compressor. System 10 may have more than one compressor 38 connected in one or more refrigerant circuits.

Refrigerant vapor delivered to condenser 26 enters into a heat exchange relationship with a fluid, for example, air or water, and undergoes a phase change to a refrigerant liquid as a result of the heat exchange relationship with the fluid. The condensed liquid refrigerant from condenser 26 flows to evaporator 42. Refrigerant vapor in condenser 26 enters into the heat exchange relationship with water, flowing through a heat exchanger coil 52 connected to a cooling tower 54. Alternatively, the refrigerant vapor is condensed in a coil with heat exchange relationship with air blowing across the coil. The refrigerant vapor in condenser 26 undergoes a phase change to a refrigerant liquid as a result of the heat exchange relationship with the water or air in heat exchanger coil 52.

Evaporator 42 may include a heat exchanger coil 62 having a supply line 56 and a return line 58 connected to a cooling load 60. Heat exchanger coil 62 can include a plurality of tube bundles within evaporator 42. A secondary liquid, for example, water, ethylene, calcium chloride brine, sodium chloride brine, or any other suitable secondary liquid travels into evaporator 42 via return line 58 and exits evaporator 42 via supply line 56. The liquid refrigerant in evaporator 42 enters into a heat exchange relationship with the secondary liquid in heat exchanger coil 62 to chill the temperature of the secondary liquid in heat exchanger coil 62. The refrigerant liquid in evaporator 42 undergoes a phase change to a refrigerant vapor as a result of the heat exchange relationship with the secondary liquid in heat exchanger coil 62. The vapor refrigerant in evaporator 42 exits evaporator 42 and returns to compressor 38 by a suction line to complete the cycle. While system 10 has been described in terms of condenser 26 and evaporator 42, any suitable configuration of condenser 26 and evaporator 42 can be used in system 10, provided that the appropriate phase change of the refrigerant in condenser 26 and evaporator 42 is obtained.

In one embodiment, chiller system capacity may be controlled by adjusting the speed of a compressor motor driving compressor 38, using a variable speed drive (VSD).

To drive compressor 38, system 10 includes a motor or drive mechanism 66 for compressor 38. While the term “motor” is used with respect to the drive mechanism for compressor 38, the term “motor” is not limited to a motor, but may encompass any component that may be used in conjunction with the driving of compressor 38, such as a variable speed drive and a motor starter. Motor or drive mechanism 66 may be an electric motor and associated components. Other drive mechanisms, such as steam or gas turbines or engines and associated components may be used to drive compressor 38.

The control panel executes a control system that uses a control algorithm or multiple control algorithms or software to control operation of system 10 and to determine and implement an operating configuration for the inverters of a VSD (not shown) to control the capacity of compressor 38 or multiple compressors in response to a particular output capacity requirement for system 10. The control algorithm or multiple control algorithms may be computer programs or software stored in non-volatile memory 76 of control panel 50 and may include a series of instructions executable by microprocessor 70. The control algorithm may be embodied in a computer program or multiple computer programs and may be executed by microprocessor 70, the control algorithm may be implemented and executed using digital and/or analog hardware (not shown). If hardware is used to execute the control algorithm, the corresponding configuration of control panel 50 may be changed to incorporate the necessary components and to remove any components that may no longer be required.

Chiller system 10, as illustrated in FIG. 3, includes compressor 38 in fluid communication with an oil separator 46. An oil and refrigerant gas mixture travels along discharge pipe 64 from compressor 38 to oil separator 46. Compressor 38 is in fluid communication with oil separator 46 via oil return line 110. Condenser 26 is provided in fluid communication with oil separator 46, and refrigerant gas travels from oil separator 46 to condenser 26. At condenser 26, refrigerant gas is cooled and condensed into a refrigerant liquid, which is in turn transmitted to evaporator 42 through expansion valve 61. At evaporator 42, heat transfer takes place between the refrigerant liquid and a second fluid that is cooled to provide desired refrigeration. The refrigerant liquid in evaporator 42 is converted into a refrigerant gas by absorbing heat from the chilled liquid and returns to compressor 38. This refrigeration cycle continues when the chiller system is in operation.

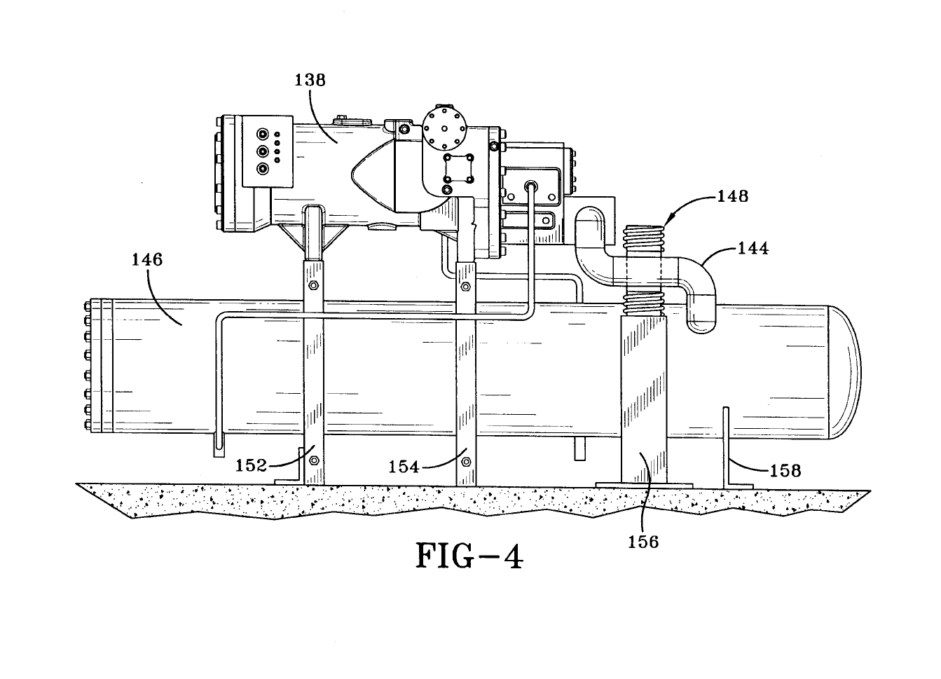

FIG. 4 shows an exemplary embodiment of a screw compressor 138 for use with a chiller, similar to FIG. 2. Discharge vapor from screw compressor 138 is provided to an oil separator 146 via a tube 144 interconnecting the screw compressor and the oil separator. As discussed in additional detail in U.S. Pat. No. 7,413,413, issued to Applicant and incorporated by reference in its entirety, discharge vapor generated by rotors or screws of screw compressor 138 produce pressure pulses as the pressurized fluid is discharged at the discharge port of the compressor. These pressure pulses are generated by the compressor at increments of the operating speed of the driven rotor, and act as significant sources of audible sound within the system.

To eliminate or minimize the undesirable sound, noise attenuation devices or systems can be installed/used. One example of a noise attenuation system is a dissipative or absorptive muffler system typically located at the discharge of the compressors. However, the use of muffler systems to attenuate sound can be expensive, depending upon the frequencies that must be attenuated by the muffler system. Typically, the lower the frequency of the sound to be attenuated, the greater the cost and size of the muffler system. In addition to the cost of the muffler system, the muffler system can restrict heating or cooling, as well as air flow in the vapor compression systems, thereby reducing operating efficiencies.

Alternately, an attenuator 148, such as in the form of electromagnetic bearings and utilizing active magnetic technology, as contained in U.S. application Ser. No. 12/189,471, assigned to Applicant and incorporated by reference in its entirety, may be installed/used for noise attenuation. An attenuator operating with magnetic technology, for purposes herein, may be referred to as a magnetic attenuator, an electromagnetic attenuator, an attenuator system, an attenuator, or the like. As further shown in FIG. 4, attenuator 148 is supported by a base 156 that is secured to the floor or other structure. Bases 152, 154 and 158 similarly provide structural support for oil separator 146 and compressor 138. In an alternate embodiment, one or more of the bases can provide structure support for one or more of oil separator 146, compressor 138 and attenuator 148.

Attenuator 148 may operate in either an active or passive mode in order to provide noise attenuation by exerting a force on tube 144. While generally shown in FIG. 4, attenuator 148 at least substantially surrounds tube 144, such as surrounding a portion of the circumferential periphery of the tube, or in an alternate embodiment, a non-rotating portion of an apparatus or system. In a passive mode, attenuator 148 dampens vibration of tube 144 by exerting a force along at least a portion of the tube that is sufficient to maintain the position of tube 144 in a substantially fixed position. That is, the force is sufficient to secure and substantially prevent tube 144 from vibrating. Alternately, attenuator 148 may operate in an active mode, in which attenuator 148 generates an oscillating magnetic field having both a frequency and magnitude substantially equal and opposite to vibrating tube 144, in order to achieve a substantial reduction of vibration, and thus, noise generated by the tube. By virtue of positioning attenuator 148 exterior of tube 144 substantially without physical contact with the tube, vibration/noise attenuation may be achieved substantially without restricting cooling or air flow that could otherwise be provided to the tube, nor would the attenuator inhibit heat transfer or restrict flow of fluid passing through the tube.

It is to be understood that the electromagnetic attenuator may be utilized in applications totally unrelated to HVAC&R, which applications may or may not involve the flow of fluids, including systems susceptible to vibration/noise resulting from resonant frequencies, such as by motor operation or other sources. For example, in addition to compressor and piping systems, the electromagnetic attenuator may be utilized for use with line shafts, blowers, fans or other system components. The attenuator would also be particularly desirable in variable speed drive applications where an infinite numbers of resonances can be encountered. In an active device, feedback from the vibrating element could adjust to attenuate any number of resonances where a fixed muffler will not be as effective.

In another embodiment, an attenuator system may include more than one electromagnetic attenuator, such as a screw compressor having an outlet tube that bifurcates into multiple tubes. In a further embodiment, the multiple attenuators may be supported from a single base. In another embodiment, more than one attenuator may be used, in which at least one attenuator operates in an active mode, or alternately, at least one attenuator operates in a passive mode, irrespective of the support arrangement of the attenuators.

In yet another embodiment, the attenuator may not be structurally supported. That is, instead of attenuator 148 being structurally secured by a base, such as base 156 in FIG. 4, a mass or weight, such as an annular ring (not shown) that substantially surrounds a portion of the circumferential periphery of the attenuator may act as a basis for applying an attenuating radial force to tube 144, whether operating in an active or passive mode as previously discussed. In one embodiment, stops may be secured to the tube to prevent movement of the attenuator in a direction transverse to the radial direction of the tube. In a further embodiment, the tube may be noncircular in cross section.

While only certain features and embodiments of the invention have been shown and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

What is claimed is:

1. An apparatus comprising:
a magnetic attenuator substantially surrounding a non-rotatable portion of the apparatus;
wherein the magnetic attenuator achieves a reduction of vibration associated with operation of the apparatus during operation of the magnetic attenuator.

2. The apparatus of claim 1, wherein the magnetic attenuator operates in an active mode.

3. The apparatus of claim 1, wherein the magnetic attenuator operates in a passive mode.

4. The apparatus of claim 1, wherein the magnetic attenuator is structurally supported.

5. The apparatus of claim 1, wherein the apparatus is an HVAC&R system.

6. The apparatus of claim 5, wherein the HVAC&R system comprises a screw compressor.

7. A method of reducing noise associated with an apparatus comprising:
installing a magnetic attenuator substantially surrounding a non-rotatable portion of the apparatus; and
operating the magnetic attenuator during operation of the apparatus.

8. The method of claim 7, wherein the magnetic attenuator is structurally supported.

9. The method of claim 7, wherein the apparatus is an HVAC&R system.

10. The method of claim, wherein the HVAC&R system comprises a screw compressor.
